(19) United States
(12) Patent Application Publication
(10) Pub. No.: US 2008/0306799 A1
(43) Pub. Date: Dec. 11, 2008

(54) Method and system for providing maintenance & management services for long-term capital assets, equipment or fixtures by providing a warranty

(75) Inventors: Victor Sopko, III, Northfield Center, OH (US); Carl Houk, Burke, VA (US)

Correspondence Address: REED SMITH LLP, Suite 1400, 3110 Fairview Park Drive, Falls Church, VA, 22042, US

(73) Assignee: Tremco, Inc.

(21) Appl. No.: 11/822,625

(22) Filed: Jul. 9, 2007

Related U.S. Application Data
(63) Continuation-in-part of application No. 09/935,843, filed on Aug. 24, 2001, now Pat. No. 7,249,030.

(51) Int. Cl. G06Q 10/00

(52) U.S. Cl. 705/8

(57) ABSTRACT

A method includes the steps of diagnosing existing conditions of long-term capital assets, equipment or fixtures, providing a performance warranty on the long-term capital assets, etc. The performance warranty is negotiated and signed prior to on-site inspection so as to transfer from owner to a provider the risk of maintaining performance of the long-term capital assets, etc. during a performance warranty term and within a standard or performance. Optionally, the performance warranty includes a condition warranty which guarantees conditions of the long-term capital assets, equipment or fixtures by component at the end of the performance maintenance warranty so as to guarantee the long-term capital assets, equipment or fixtures will operate for another extended period after the performance warranty, without performing by the provider any further maintenance thenafter.

### BACKGROUND OF THE INVENTION

This application is a continuation-in-part of U.S. patent application Ser. No. 09/935,843 filed Aug. 24, 2001, the entire text of which is hereby incorporated by reference.

### FIELD OF THE INVENTION

The invention generally relates to a method for providing maintenance service for long-term capital assets, equipment or fixtures by providing a warranty on the long-term capital assets, equipment or fixtures in conjunction with a purchase of initial maintenance service while the warranty transfers from an owner to a provider the risk of maintaining performance of the long-term capital assets, equipment or fixtures within a reasonable range from a predetermined start-up standard. In particular, the long-term capital assets, equipment or fixtures are first repaired to reach the start-up standard and then maintained according to a maintenance schedule. For purposes of this invention, the term “owner” includes any person, party or entity that has ownership rights, a security interest, trusteeship responsibility or other legal control over the capital equipment or fixture in question, while the term “provider” shall refer to the person, party or entity responsible for the operation of the maintenance service and warranty.

The performance warranty may include a condition warranty that the long-term capital assets, equipment or fixtures will have an additional life time period after the end of the performance warranty term, without performing by the provider any further maintenance thenafter.

At the end of the performance warranty term, a determination is made by component as to the remaining life expectancy of the capital assets, equipment or fixtures. If the estimated remaining life expectancy of a component is shorter than the guaranteed additional life expectancy, the provider will restore or replace the component at issue to ensure that the long-term capital assets, equipment or fixtures will perform the additional life time period after the end of a predetermined fixed term, without performing by the provider any further maintenance thenafter.

### DESCRIPTION OF RELATED ARTS

Long-term capital assets, equipment or fixtures require good design, quality materials and proper installation to perform successfully. Capital asset is a long-term asset that is not purchased or sold in the normal course of business. Generally, it includes fixed assets, e.g., land, buildings, equipment, fixtures, furniture, and machinery, etc. Generally, these are assets that can't be turned into cash quickly. Capital equipment is assets that a business uses to manufacture a product or deliver a service. A fixture is a piece of equipment which has been attached to real estate as an integral part of the real property. For example, lighting fixtures, heaters, window boxes, awnings, window shades, doorknobs, or other item which is bolted, nailed, screwed or wired into the wall, ceiling or floor. Trade fixtures are those which a merchant would normally use to operate the business and display goods and may be removed at the merchant's expense for any necessary repair.

In most countries a capital cost deduction applies to require or allow a purchaser to write off the cost of acquiring the asset over time. Rather than writing off the entire cost of acquisition in one year, it is written off over multiple years to reflect the fact that it is used in each year to do things and wears down or is used up or obsolete to some degree. The period of time over which this occurs can range typically from 2 years for software to 30 years for buildings.

Once long-term capital assets, equipment or fixtures have been installed, nothing is more critical to its long-term performance than proper maintenance. For example, roof leaks not only can be difficult to detect but providing proper repair will insure lasting performance. The life of any roofing system is finite. Most roofing materials begin to exhibit water infiltration within 20 years after installation. Distress conditions and leaks on roofs are more likely to emerge at certain predictable areas, such as at punctures or seams in membranes. Leaks also often occur where pipes or vents penetrate the roof membrane, as well as at roof perimeters where roofing systems transition to other materials. By identifying areas that are prone to developing problems, maintenance and engineering managers can take steps to prevent roof problems cost effectively, rather than resorting to roof replacement. Rather than relying upon common sense to dictate maintenance and repairs, there is a need for a systematic approach. This is evident in view of the fact that each roof exhibits different qualities and the longevity and cost of replacement depends on the quality of the roof at the outset and the quality of labor and materials involved. Roof renovation and preventive maintenance can extend roof life up to 100%. The cost of renovating a roof is about ten to thirty percent of the cost of a new roof. If action is taken in time, there is no need to re-roof. The development of new technology and techniques in leak prevention and maintenance have resulted in an efficient and effective innovation in roof maintenance.

Roofing is not that same old kettle of hot asphalt that the construction industry has seen applied with more or less the same techniques for over a hundred years. It has become an ever-changing focus on technology and the waterproofing relationship to the building envelope. With over twenty generic types of roof systems and scores of manufacturers producing countless numbers of products, the combinations of roofing systems can be overwhelming. It is somewhere within those aforementioned boundaries that the fundamentals of roofing facts and fiction get a little blurry. Roofing, as any other industry, will evolve in cycles based upon its current technology and profitability of application.

A video or infrared analysis of a roof will identify most of the potential problem areas. After restoration of the roof, a routine maintenance program will ensure the performance of the roof There are many companies providing roof maintenance programs. Benefits of a roof maintenance program include the ability to detect visible problems in the early stages, to avoid costly repairs caused by water damage, to record the maintenance history, and to prevent leaks before they occur, allow planning and budgeting for the maintenance service.

Under the MAGCO's Roof Maintenance Program, each roof was first evaluated to determine its serviceability, based on age, condition and quality; then it was placed in different categories of maintenance services. The staff of the MAGCO's Roof Maintenance Program recommended initial corrective repairs to be completed prior to a yearly service contract being offered. The costs varied depending on category and building size. However, the information was not organized electronically.

Roof Consultant's, Inc.'s Roof Maintenance Program was implemented at the beginning of the roofs life for a new roof or an existing roof after rehabilitation to bring the roof up to a maintainable condition. Once the existing conditions were corrected, Roof Consultant's, Inc. began its five year Roof Maintenance Program and continue to maintain the roof system throughout its duration. During the term of the maintenance agreement, Roof Consultant's, Inc. visited the facility a minimum of two times annually. Upon each visit, Roof Consultant's, Inc. made arrangements for corrective and preventive repairs to keep the roof in a serviceable condition. If the roof is properly functioning at the end of the agreement, Roof Consultant's, Inc. offered the option of extending an otherwise conventional maintenance agreement.

Anthony Roofing Ltd. (ARL) provided five discreet maintenance programs, modest to aggressive, to suit different needs and budgets. ARL worked with a client to develop a plan to maintain and protect a specific roofing asset with separate pieces of tools such as Roof Condition Analysis, Multi-year Computerized Budget Planning, CAD Drawing and Documentation, Emergency Repair Service, Regular Preventive Maintenance, and Leak-Free Warranty Repairs. In particular, its only filly-computerized system, the Multi-Year Computerized Budget Planning System, was separated from, rather than integrated with, its semi-computerized system, the CAD Drawings And Documentation System. The Multi-Year Computerized Budget Planning System applied computer software to provide multi-year budget planning information for one building, or for multiple facilities. The budget information was prioritized based upon the condition of each roof. A permanent database was maintained to track real costs over the long-term, so that the Multi-Year Computerized Budget Planning System could identify problem areas, and also saw the cost benefits of maintaining your roofing asset. Anthony's CAD Drawings And Documentation System was manually operated by staff in the CAD department to provide drawings as part of their initial Roof Condition Analysis, or to document conditions during the term of a maintenance agreement.

Building owners' purchasing decisions of maintenance services typically are influenced by warranties provided. Such conventional warranties provided by roofing materials manufacturers or roofing contractors are not intended to transfer any substantive level of risk from the building owner to the warranty provider. A building owner cannot neglect or ignore the need for roof system maintenance after a new roof system that features a long-term warranty is installed. Most roof system warranties for an existing roof are reactive, rather than proactive, solutions to roofing problems. For example, most warranties provide for only limited repairs once a roofing problem (e.g., leakage) is detected if the problem is included within the warranty's limited coverage, as they are only responsible for meeting the service requirements as defined by the agreed scope of work. Also, most roof system warranties contain specific provisions that require building owners to properly maintain roof systems during the warranties' terms. In many cases, for legitimate reasons, the building owners are unable or unwilling to perform their own maintenance in conjunction with a traditional warranty. A traditional warranty falls short of meeting the need for roof system maintenance. Therefore, in order to achieve an effective roof system maintenance program, a vehicle for transferring roof performance risk from the build-owner to another party is needed.

Generally, a private/commercial build-owner may purchase a service or maintenance program for as long a time period as the industry offers; current industry standards limit such programs to five years. However, current U.S. public financing laws generally limits the purchase of service agreements by a public agency to one-year increments. Consequently, a vehicle for providing maintenance service beyond one-year increments to the public sector is also needed.

There are many systems for diagnosing problems associated with long-term fixtures or equipment. For example, U.S. Pat. No. 4,598,273 shows a leak detection system for roofs. In combination with the detecting units, position and direction locator apparatus are used to localize the source of the leak and the extent of any water damage caused thereby (Abstract). Some inventions further include a failure-anticipating feature. U.S. Pat. No. 5,729,474 shows a failure-anticipating system for air-conditioning equipment.

U.S. Pat. No. 5,343,387 shows a cyclical maintenance worker and work schedule table preparation system. The system focuses on matching labor with scheduled maintenance work. The system describes a worker data memory for storing the names, work details, last working dates, but it fails to explain how the frequencies of the maintenance work of buildings are decided. Further, it does not mention a predetermined start-up standard or repairing the fixtures or equipment to reach a predetermined start-up standard.

U.S. Pat. No. 6,067,486 shows an aircraft maintenance system which simply accepts the remaining life of a part rather than implementing repairs to the part to reach a predetermined start-up standard as in the present invention. U.S. Pat. No. 4,755,957 shows an air-conditioning servicing system which does teach diagnosing problems of air-conditioning equipment and repairing the equipment to reach a predetermined standard. However, such a standard is not a start-up standard of a maintenance schedule or a maintenance contract.

An owner of an aircraft or other long-term capital equipment usually signs an extended service contract with an insurance company and hires any authorized maintenance service providers to performance the maintenance service on an on-demand basis. The owner has to file a claim with the insurance company for covered mechanical breakdowns or failures, then contacts a repair service provider to perform the actual repair or replacement. The insurance company only pays for the repair or replacement cost, i.e., assuming the financial risk of maintaining performance but not the actual maintenance performance risk by repairing, developing a maintenance schedule, and maintaining the long-term capital equipment. In particular, the insurance company only covers particular mechanical breakdowns or failures, e.g., drive axle, transmission case, etc. but excluding wear and tear. The owner has the responsibility of hiring authorized maintenance service providers to check and maintain the equipment or fixtures according to maintenance schedule recommended by the original manufacturer and of paying the cost of repairing or replacing regular wear and tear.

As described in U.S. patent application Ser. No. 09/935,843 (hereinafter “App '843”), a professional roofing contractor offers periodic maintenance inspections throughout the year, which help ensure a project complies with the standards specified in the warranty. To effectively manage roof assets, one must first determine the existing conditions. The integrity of a roofing system is reliant on more than the roofing membrane alone. There are other components which directly affect the overall performance of the system. These components include; the substrate (or deck), insulation, penetrations, flashings (Parapet wall, Curb, Gutter, Roof to wall termination etc.), and roof top equipment, etc. A maintenance program usually consists of a detailed visual examination of the roof system, flashing and insulation to identify potential problem areas. Establishing a regular roof system maintenance program is as important as selecting a professional roofing contractor and the proper roof system for a building. The most effective way to keep a roof system performing over time is for the owner or maintenance manager to develop a long-term relationship with a professional roofing contractor. A professional roofing contractor knows the local building codes and practices, understands the components of different roof systems and can make recommendations about materials and roof systems for a specific building. A professional contractor also can respond quickly with trained, experienced workers if a problem arises. Maintenance programs offer many advantages. By establishing a maintenance program, a maintenance executive is taking a proactive approach rather than a reactive one—identifying a problem during its early stages and scheduling regular maintenance checks also can reveal potential areas for leaks before they happen. A maintenance program ensures a planned approach to managing a roof system and allows preparation for long-term capital assets, expenditures. Developing a relationship with a professional roofing contractor allows the response time to be greatly improved.

The maintenance service provider of App '843 assumes both of the actual performance work and financial risk (not just financial risk as an insurance company). The maintenance service provider of App '843 not only actually performances repair, but also checking and maintaining the equipment or fixtures according the maintenance schedule on a routine basis without being contacted by the owner, rather than the “on demand” basis. The maintenance service provider of App '843 maintains and pays for the whole covered equipment or fixtures, rather than just particular mechanical breakdowns or failures but excluding wear and tear. In particular, App '843 deliberately covers wear and tear, such as of a roof. In addition, the maintenance service provider of App '843 develops the maintenance schedule, while the insurance company requires the owner to follows a maintenance schedule development by the original manufacturer. The prior art does not teach or suggest repairing the long-term capital assets, assets, equipment or fixtures to reach the start-up standard. The start-up standard of App '843 is negotiated and determined by the owner and the provider, rather than the fixed standard promulgated by governmental agencies or relevant industries. In addition, the start-up standard of App '843 is negotiated and determined to bring the long-term capital assets, assets, equipment or fixtures at least to within industry acceptable parameters so as to maintain the long-term capital assets, assets, equipment or fixtures over the specified time of the warranty. In contrast, the insurance company does not cover pre-existing problems such as dents or actually maintain the long-term capital equipment but simply requires the owner to follow the maintain schedule suggested by the original manufacturer. The insurance does not negotiate or determine any start-up standard, and much less about a start-up standard to bring the long-term capital assets, assets, equipment or fixtures at least to within industry acceptable parameters so as to maintain the long-term capital assets, equipment or fixtures over the specified time of the warranty.

In short, the prior art system was designed to reduce the warranty and financial exposure of the part supplier or an original equipment manufacturer (OEM) of a new aircraft or other long-term capital equipment, and to improve their quality assurance program without transferring risk of ensured maintenance performance of any pre-owned long-term capital assets, equipment or fixtures, and the insurance company only assume financial risk of repair or replace mechanical breakdowns or failures of a vehicle, but not performing the actual maintenance. On the other hand, App '843 transfers risk of cost and actual maintenance performance of the long-term capital assets, equipment or fixtures to the provider. The prior art system and the insurance policy are merely reactionary—triggered by a fault that has occurred and on-demand. On the other hand, App '843 is proactive and is intended to anticipate and resolve problems before they become severe.

Generally, a private/commercial build-owner may purchase a service/maintenance program for as long a time period as the industry offers, which was typically limited by industry standards to five years. However, U.S. public financing laws limited the purchase of service agreements by a public agency to one-year increments. App '843 provides a vehicle for providing maintenance service beyond one-year increments to the public sector. This is unique in its approach as a business process. Typically, asset owners make capital expenditures and then receive a warranty. They may also additionally purchase service agreements but typically have to arrange for the regular service as part of their contract. This process involves multiple steps that, when assembled, offers the asset owner unprecedented long-term performance with little or no required interaction on his part. The risk of guaranteed performance is transferred to the service provider. As such, the service provider becomes fully responsible for the cost and performance of maintenance, which was unheard of prior to the filing date of App '843. This program is not limited to new purchases. It can be used for existing assets, regardless of the original asset provider.

It involves the evaluation of the asset and bringing it up to mutually acceptable, industry recognized, minimum performance levels. All information obtained during the assessment and upgrade is recorded and tracked in a specially developed computer program. This program is then used to track the ongoing maintenance/service visits that are automatically dispatched without request from the asset owner at prearranged intervals appropriate to the asset and the owner's needs. The asset owner receives regular updates on the current asset condition and the maintenance work carried out as recorded in the computer program. Should the asset fail to perform as guaranteed, the owner contacts the service provider and workers are dispatched to restore the asset to a condition of proper performance at no additional cost. This unique combination of analysis, upgrade, record keeping, ongoing automatic service and guaranteed asset performance provides a valuable service to the asset owner which was not available in the prior art. Among the advantages of the present invention, the structure and operation of App '843 allows the owner to better plan and prioritize limited budget resources. App '843 offers a warranty of a fixed or predictable price to users, such as federal, state or local government agencies, as well as private entities that maintain large inventories of long-term capital equipment.

There is a need to allow an owner to even further transfer performance and financial risk to the maintenance service & warranty provider so that the owner can better predict, plan and prioritize the limited funds and other resources for maintaining long-term capital equipment that all entities, government or private, face everyday.

### SUMMARY OF THE INVENTION

It is a purpose of this invention to maximize the life cycle of long-term capital assets, equipment or fixtures.

It is another purpose of this invention to computerize and integrate all the relevant systems for providing maintenance service for long-term capital assets, equipment or fixtures.

It is another purpose of this invention to provide a vehicle for transferring the performance risk of long-term capital assets, equipment or fixtures from the build-owner to another party.

It is another purpose of this invention to provide a vehicle for providing maintenance service for long-term capital assets, equipment or fixtures beyond one-year increments to the public sector.

It is another purpose of this invention to offer to an owner of long-term capital assets, equipment or fixtures, or an buyer of new or used long-term capital assets, equipment or fixtures, a warranty which transfers performance and financial risk to the maintenance service and warranty provider.

It is another purpose of this invention to offer maintenance warranty even prior to visiting the sites to examine/inspect the long-term capital assets, equipment or fixtures.

It is another purpose of this invention to provide a new condition categorization system for the long-term capital assets, equipment or fixtures (e.g., roofs) beyond the tradition simply good (nothing to be done) or bad (to be replaced) conditions so as to provide different level of maintenance and extend life expectancy accordingly.

It is another purpose of this invention to allow the owner to even further transfers performance and financial risk to the maintenance service & warranty provider so that the owner can cap costs, better predict, plan and prioritize the limited funds and other resources for maintaining long-term capital equipment that all entities, government or private, face everyday.

It is still a further purpose of this invention to maximize the owner's return on investment (ROI) or rate of return (ROR) in maintaining long-term capital assets, equipment or fixtures.

It is still a further purpose of this invention to provide a vehicle for assigning additional benefits to either the owner, the estimated life expectancy of the capital assets, equipment or fixtures, the remaining life expectancy of the capital assets, equipment or fixtures as determined at the end of the predetermined time period of the warranty, and the degree to which the determined life expectancy of the capital assets, equipment or fixtures meets, falls short of or exceeds the estimated life expectancy.

It is still a further purpose of this invention to guarantee the conditions by component in the last year of the maintenance warranty (TMW) so as to guarantee the long-term capital assets, equipment or fixtures will operate for another extended period after the maintenance warranty without any human intervention, i.e., a condition warranty (CW).

It is still a further purpose of this invention to provide a vehicle for extending the useful life-expectancy of the long-term capital assets, equipment or fixtures beyond the estimated life expectancy attributed to capital assets, equipment or fixtures operated and maintained under conventional warranty programs.

### BRIEF DESCRIPTION OF THE DRAWINGS

The foregoing and additional features and characteristics of the present invention will become more apparent from the following detailed description considered with reference to the accompanying drawings in which like reference numerals designate like elements and wherein:

FIG. 1 is diagram illustrating a first embodiment of the processing methodology—life cycle approach—of the present invention;

FIG. 2A and FIG. 2B together are a flow chart illustrating the structure flow of the operation for the embodiment of the present invention;

FIG. 3 shows a details screen provided by the Roof Management & Information System according to the present invention;

FIG. 4 shows a glossary diagram screen provided by the Roof Management & Information System according to the present invention;

FIG. 5 shows a reports screen provided by the Roof Management & Information System according to the present invention;

FIG. 6 shows a task screen provided by the Roof Management & Information System according to the present invention;

FIG. 7 shows a customizing report screen provided by the Roof Management & Information System according to the present invention; and

FIG. 8 shows a task priority screen provided by the Roof Management & Information System according to the present invention.

FIG. 9 shows a cost comparison example between the prior art approach and TPW approach of the invention.

FIGS. 10-12 illustrate another cost comparison example between the prior art approach and TPW approach of the invention.

FIGS. 13-14 illustrate a third cost comparison example between a modified prior art approach, a TPW approach, and an alternative TPW approach of the invention.

### DESCRIPTION OF THE PREFERRED EMBODIMENTS

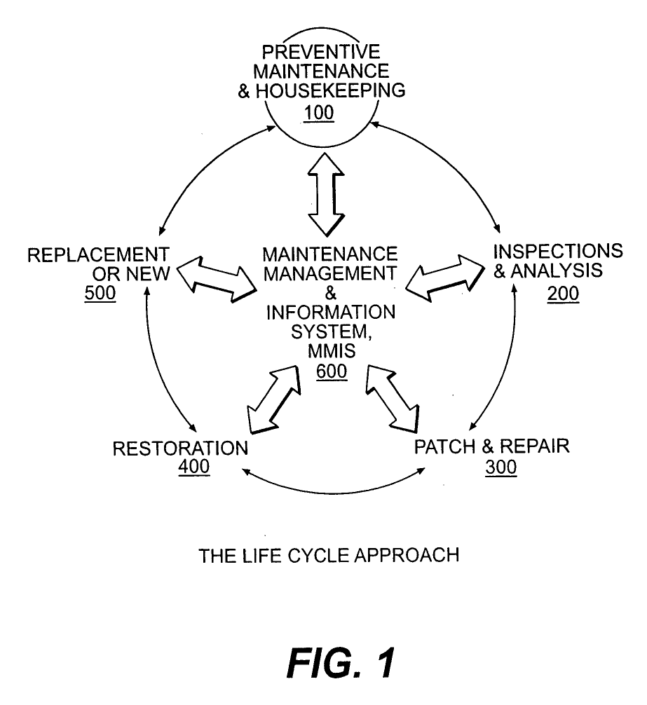

The method for providing maintenance service for long-term capital assets, equipment or fixtures takes a life cycle approach as shown in FIG. 1 to serve the desire of owners and facility managers for long term performance for their capital equipment assets. The method may start with any one of the five elements, namely, prevent maintenance & housekeeping 100, inspection & analysis 200, patch & repair 300, restoration 400, replacement or new 500, then move clockwise or counter clockwise according to the need determined by a computer- implemented maintenance management information system (“MMIS”) 600. In this example of roofing, the Roof Management & Information System (“RMIS”) is used. By offering single source responsibility through the lifetime of the capital equipment, in this case a roof, the MMIS focuses on the right roofing and weatherproofing solution best fitting the owners' budget restraints, whether it be preventive maintenance 100, repair 300, or replacement 500, rather than resorting to short-term, piece-meal measures.

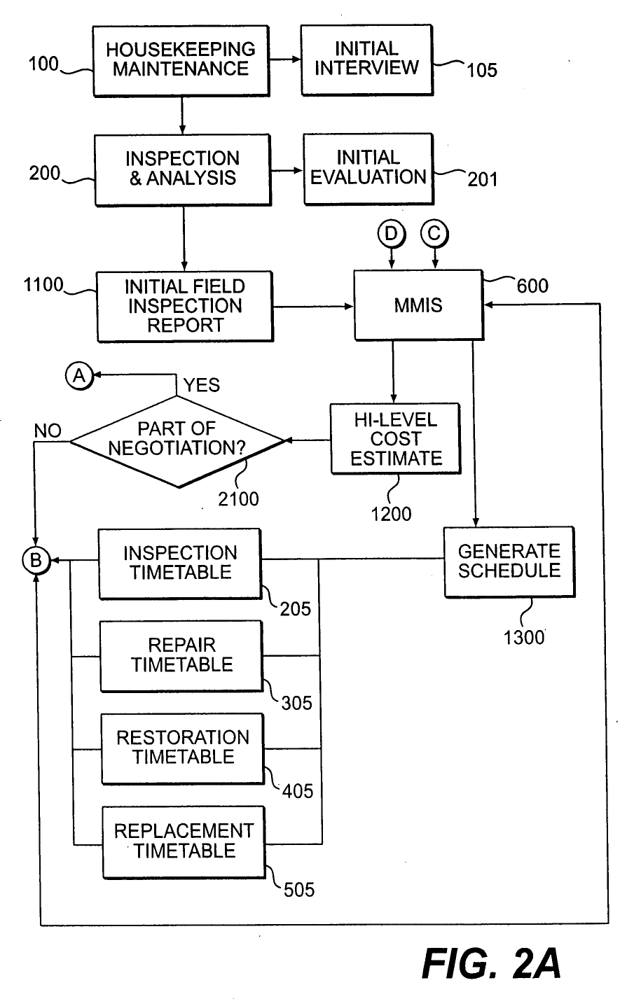

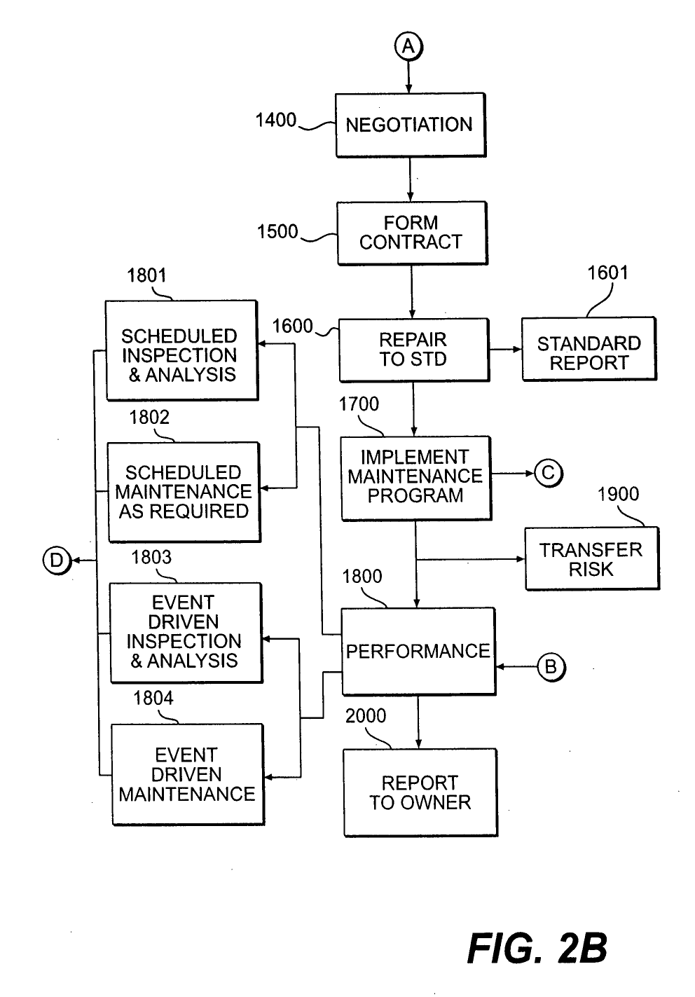

As an overview of the process starting from the step of preventive maintenance & housekeeping 100 and referring to FIGS. 2A and 2B, prior to doing any work, field advisors and technical service representatives 105 are sent to interview the owners or managers to collect the information on past roofing and weatherproofing experiences of building owners and facility managers, understanding current concerns and surveying the roof inventory to be recorded by the MMIS 600 which will determine the options for maximizing the roofing and building lifetime. The key is to provide full and single-source services from initial consultation to customized problem solving and covering all the roofing and weatherproofing needs via the life time of the roof.

The step of initial inspection and analysis 200 is performed in conjunction with the goals and budgetary considerations of the building owners and facility managers collected from the step 100. Within the step of initial inspection and analysis, a professional is sent to the facility to evaluate the physical condition of the roof and determine what work, if any, is needed to restore it to predetermined serviceable conditions 201. An initial field inspection report 1100 is then prepared that covers what the inspection has revealed. That field inspection report 1100 is then inputted into MMIS 600 that then generates the high-level cost estimate 1200. The high-level cost estimate 1200 includes recommendations for any necessary repairs along with detailed cost estimates for repairing 300, restoring 400 or replacing 500 to the predetermined serviceable conditions. The costs for conducting the initial inspection and analysis 200 and for generating the initial field inspection report 1100 may be included in the proposed contract or charged separately. As one of skill in the art would appreciate, such a report and cost estimate can have different applications in the industry, and thus has the potential of being generated for banks, mortgage agencies, or potential buyers of a property.

The high-level cost estimate 1200 is then used to negotiate the terms of the contract with the building owner or facilities manager 1400. These negotiations include determining the initial (start-up) standard conditions or a standard of performance to which the roof would be repaired, modified, improved or replaced and which would serve as the starting point for the maintenance to be performed. For example, the standard of performance may be defined as dryness of the roof. The dryness of the roof can be determined by visual inspection, electric capacitance meters, infrared cameras, electric field vector mapping, etc. Once the terms of the contract are established, the contract is then formed and finalized 1500.

With the contract in place, repairs are initiated in accordance with the initial standard conditions 1600, as determined above. Depending on the prior condition of the roof, the recommendations made in the high-level cost estimate, and the desires of the building owner or facilities manager, these standardization repairs may be minor or very extensive. In any event, the condition of the roof to be maintained has to be brought at least to within industry acceptable parameters that can be maintained over the life of the contract.

Once the standardization repairs are completed, a report 1601 of the condition of the roof as repaired is generated, whereby the maintenance program can be initiated 1700. The initiation of the maintenance program 1700, in conjunction with the terms of the contract 1500, effects two primary elements of the system: (1) the actual performance of the maintenance program is started 1800; and (2) the warranty comes into effect transferring the risk of maintaining the roof from the building owner or facilities manager (the owner) to the party conducting the maintenance program and the warranty (provider) 1900. The performance 1800 includes by operation the inputting of the report 1601 into MMIS 600 which then generates a maintenance schedule 1300 which includes timetables for inspection 205, repair 305, restoration 405, replacement 505 and other maintenance services for the period of the warranty and a breakdown of costs for the relevant maintenance according to the maintenance schedule 1300. In addition, periodic reports to the owner 2000 may be generated by the MMIS 600. For example, reports may be sent (1) after each scheduled inspection and analysis, and scheduled maintenance activities; (2) after each event-driven scheduled inspection and analysis, and scheduled maintenance activities; and/or on a regular schedule depending on the desires of the owner (e.g., monthly, quarterly, yearly).

Periodic roof maintenance plays an important part in the life of a roof system. Such a routine inspection and maintenance program is crucial to extending the life of industrial machinery and other plant systems in a facility. Routine rooftop inspection can help maximize the roofing system investment by identifying minor problems before they become major problems needing repairs. When the maintenance schedule 1300 is properly executed, it will add years of service to the roof by detecting minor problems before they become major, as well as providing better protection for the building. Although best initiated when a roof is designed and installed, a preventive maintenance program, in most cases, can be implemented at any point of the life cycle in FIG. 1 to extend the service life of a roof. The intent of preventive maintenance is to enable building owners through their warranty providers to proactively identify and implement solutions to roof system problems before they become widespread. In many cases, if a problem is identified early and properly repaired, the extent and cost of repairs will be significantly less than if problems were left unattended.

The MMIS 600 is programmed to schedule maintenance inspections 205 at least annually, but preferably at least twice a year, ideally in the spring and fall. Spring is a good time to repair roof damage incurred as a result of winter weather. Late fall is also a good time to inspect so as to secure the roof and make any required repairs before winter. In addition, the MMIS 600 may be linked with real-time databases on conditions that may affect the condition of the roof. Such real-time databases include those reporting on real-time weather, local seismic conditions, pollution levels, etc. Even more, an operator may be able enter data into the MMIS 600 in order to report the occurrence of such unusual events into the system. This allows the MMIS 600 to schedule inspections after severe or abnormal weather conditions such as winter storms, periods of icing, hailstorms, or hurricanes, earthquakes, or other events or conditions. The MMIS 600 will also note on the list for inspection any weather conditions (wind, rain, ice, and snow) to warn the crew of any weather-related safety concerns.

A preventive-maintenance inspection 200, 205 typically consists of a thorough visual inspection of a roof system and its adjacent surfaces (e.g., walls), including the membrane, flashings, copings, gutter and downspouts, roof drains, walkways, expansion joints, vent pipes, skylights, ductwork, caulking joints, electrical conduits, and any mechanical equipment on the roof, as well as mechanical equipment that can impact the roof system's waterproof integrity. Conditions typically are recorded in writing and photographed, and the documentation should be maintained in a file. Such a file can be useful during future inspections because it can provide a basis for comparison of changing roof system conditions. During an inspection, it is recommended that any debris or other materials that do not specifically belong on the roof be removed.

The MMIS 600 generates an inspection checklist, which includes but is not limited to (for the roof system example) flashing, pitch pockets, caulk, support structures, fascia and roof edging materials, termination points. Other important steps of inspection include: making a preliminary assessment to identify any major, potential problems, finding and fixing vulnerable spots, examining areas around rooftop equipment, cleaning gutters and drains, keeping accurate, detailed records, reviewing the warranty and notifying the insurer, while minimizing rooftop traffic.

A field investigator conducting the inspection 200, 205 examines the construction and condition of the roof system as well as its components, and then records that information in a customized PC-compatible management database. With this information, the MMIS 600 identifies areas that need attention, makes recommendations and prioritizes tasks based on available budgets. The MMIS 600 then generates a report and quotation as part of the cost estimate 1200. If the cost estimate 1200 is generated in conjunction with a contract negotiation, the cost estimate 1200 is presented in accordance with steps 1400 and 1500. Otherwise, if generated during the performance of the maintenance program 1800, the cost estimate is reported to the client.

The objective of the analysis is to provide accurate cost effective services for the highest “Return On Investment” (ROI). The actual cost of roofing is expressed according to the formula: (Material Cost) +or −(Assessment Accuracy)×(Contractor Markup, Labor, Overhead, Scope of Work)=(Bid Cost)+(Quality Assurance Inspections)+(Preplanning Assessment, Design, Specifications)=(Actual Cost of Roofing (ACR)).

Any restructuring of the service schedule 1300 changes the ACR. The MMIS 600 assesses any roof's condition and plan a course of action (“if”, “when”, “cost”) to repair or replace that roof with accurate baseline information collected in steps 100, 200 or 205. Other commercial roof asset management programs merely provide fragmented practices or separating key functions, which ultimately result in an unacceptable level of performance and ultimately, an inaccurate/unacceptable “Return On Investment”.

The scheduling of repairs 305, restorations 405 and replacements 505 are dependent on the data gathered by the maintenance inspections 205 which is inputted into the MMIS 600. The steps performed in accordance with each of those schedules would be, as one of skill in the art would understand, in accordance with the terms of the contract 1500, industry accepted standards for repair, restoration or replacement of a roof, or the specific requirements of the materials used in the roof being maintained.

For example, as a building ages, the abuse that the roof experiences from weather, movement, modifications and traffic may cause minor problems, that if not fixed, could become major problems. In the roof membrane and flashings, these could be blisters, splits, and tears; while walls and other surfaces may experience cracking and mortar deterioration. Although not severe enough to warrant a large project, they do threaten the system's integrity and need to be repaired promptly. If repairs 300 based on the schedule 305 are necessary, routine repairs sometimes can be carried out immediately. If repairs cannot easily be made at the time of inspection 200, 205, they should be implemented as soon as possible to avoid further roof system deterioration.

That same approach applies to restoration 400 or 405, and replacement 500 or 505. Restoration 400 or 405 is a cost-effective, proactive maintenance process designed to prolong the life of a functioning build-up, modified, singly ply or metal roof. The MMIS 600 determines from laboratory analysis data, for example, how to restore or upgrade the performance of the existing roof and its components by identifying and repairing defects in addition to providing a new top coat to restore waterproofing continuity. Replacement 500 or 505 is necessary when deterioration of the roof or deck is so extensive that it cannot be corrected by repair or restoration. Should the roof require replacement (or if the owner is planning to roof a new structure), the MMIS 600 can specify the most suitable roofing systems for the conditions that the roof is anticipated to experience.

Within the step of the performance of the maintenance schedule 1800, inspections and analysis scheduled by the MMIS 600 (see step 205) are conducted 1801 and reported back to the MMIS. In accordance with the data generated by the inspection 1801, regular maintenance and repair activities are conducted 1802 in order to attend to regular wear and tear matters. When those regular repairs and maintenance are completed, the details of those repairs are reported back to the MMIS 600.

In addition, in response to unusual events or conditions such as those discussed above, the MMIS 600 will schedule event-driven inspections and analysis 1803 (see step 205). Data gathered from those event-driven inspections and analysis are reported back to the MMIS 600 so as to schedule event-driven maintenance and repair activities 1804. As those activities are completed, data on the repairs are reported back to the MMIS 600.

All the information, including photos of the roof after each service visit, is recorded in an electronic file on the roof by the MMIS 600, including its maintenance history, to keep track of its condition with periodic updates as shown by the flow of information according to FIGS. 2A and 2B.

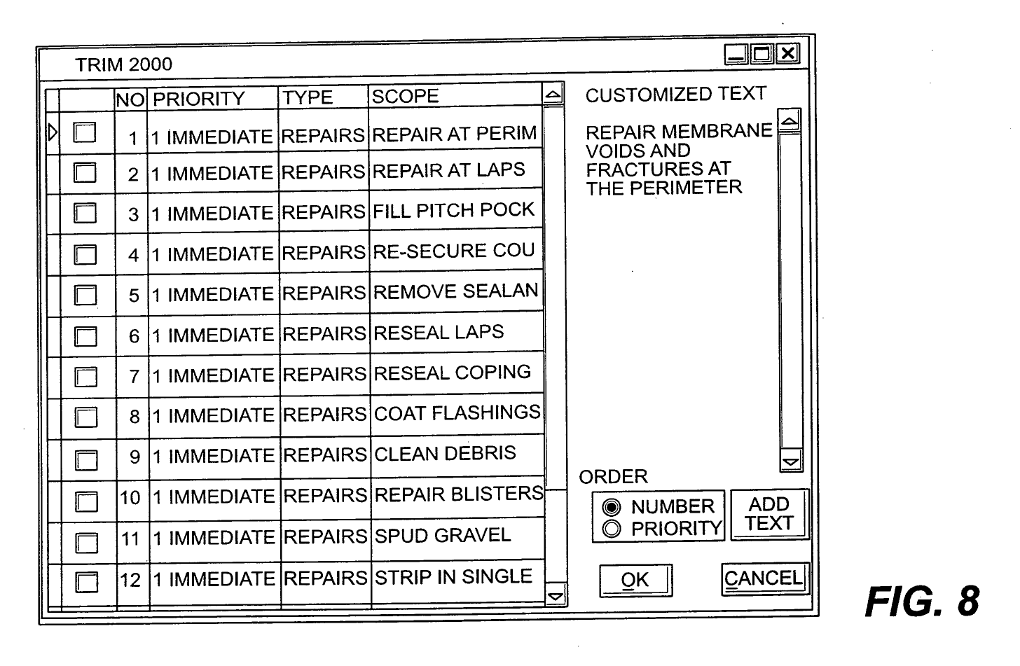

The MMIS 600 in at least one embodiment, using the RMIS as an example, is language-independent, and it supports cross-platform applications, such as Windows NT, Java, and Solaris platforms (XML, COM and CORBA), relational databases, such as but not limited to Informix, Oracle8 and SQL Server, or any spreadsheet modules. The data is easily exported into other financial spreadsheet programs so that the user can toggle between its budget and actual cost and create expense verses capital summary. Accordingly, the MMIS 600 allows the user to prioritize tasks based on available budget dollars (FIG. 8), manipulate financial data as the needs change, analyze the impact of inflation on the cost, or schedule work flow according to its exact specification.

Today's market is abundant with software programs purporting financial information relating to roofing costs. Unfortunately, a majority of these are based upon matrices and not condition specific indexes. Others, while potentially adequate, fall into a one size fits all category and are at the mercy of those providing field service information. Accurate “Return on Investment” information is basic: You need to insure that the provider you employ can i n s u r e “condition specific” field information, by seasoned personnel. This information should then provide: (1) true annualized ACR based on project restrictions for occupancy, codes, structural limitations, cost of money, etc.; (2) comparative analysis of repair versus re-roofs; (3) true regional/local unit price structure for repair and maintenance based upon the required repair materials, not generalities; and (4) transferable database translating into condition specific repair and re-roofing specifications. In another embodiment, the MMIS 600 may be designed to itemize the scope of work before proceeding so as to help the owners or managers to make an informed decision, especially during contract negotiation.

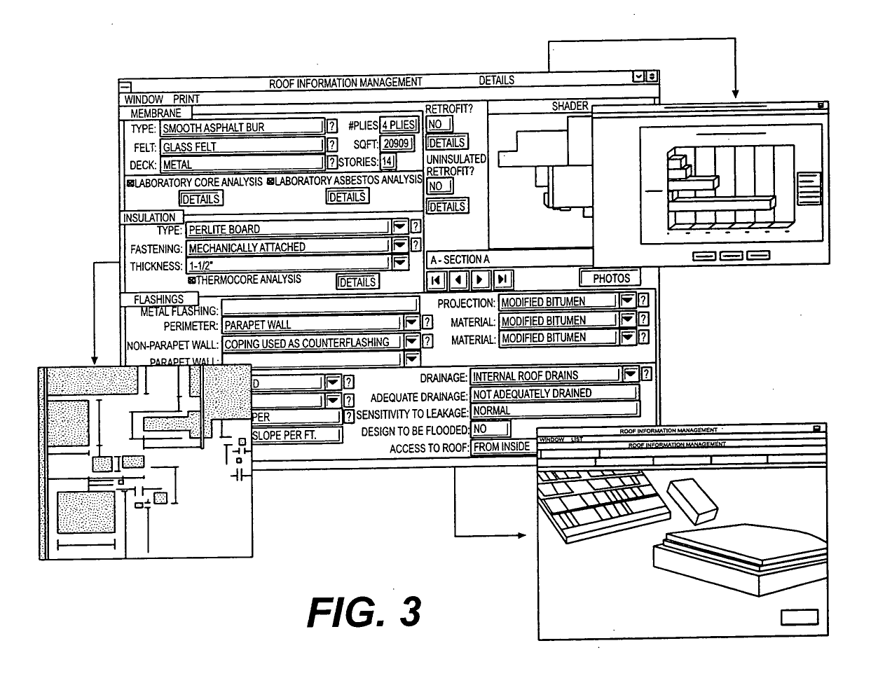

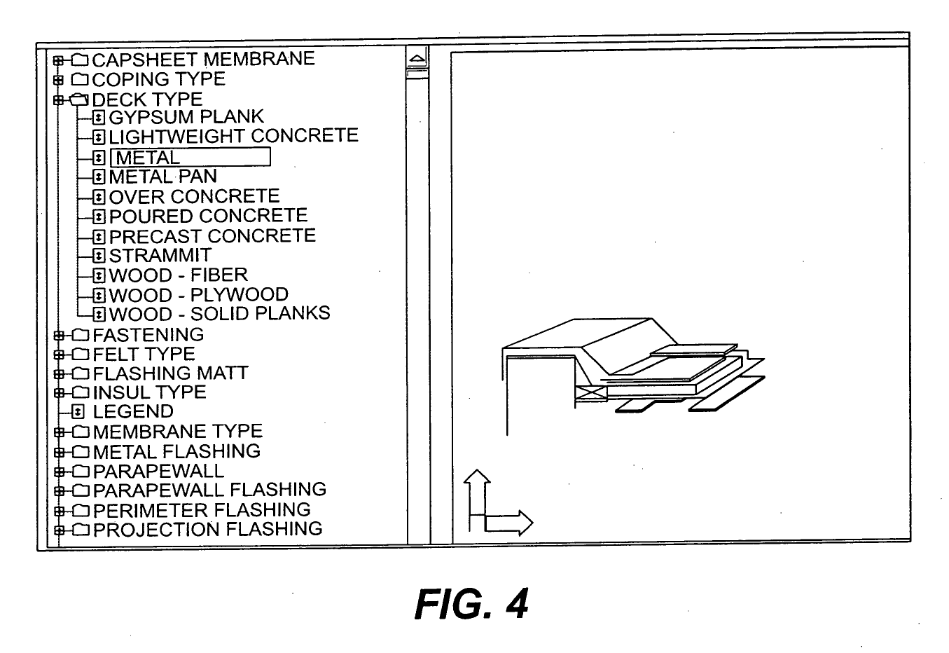

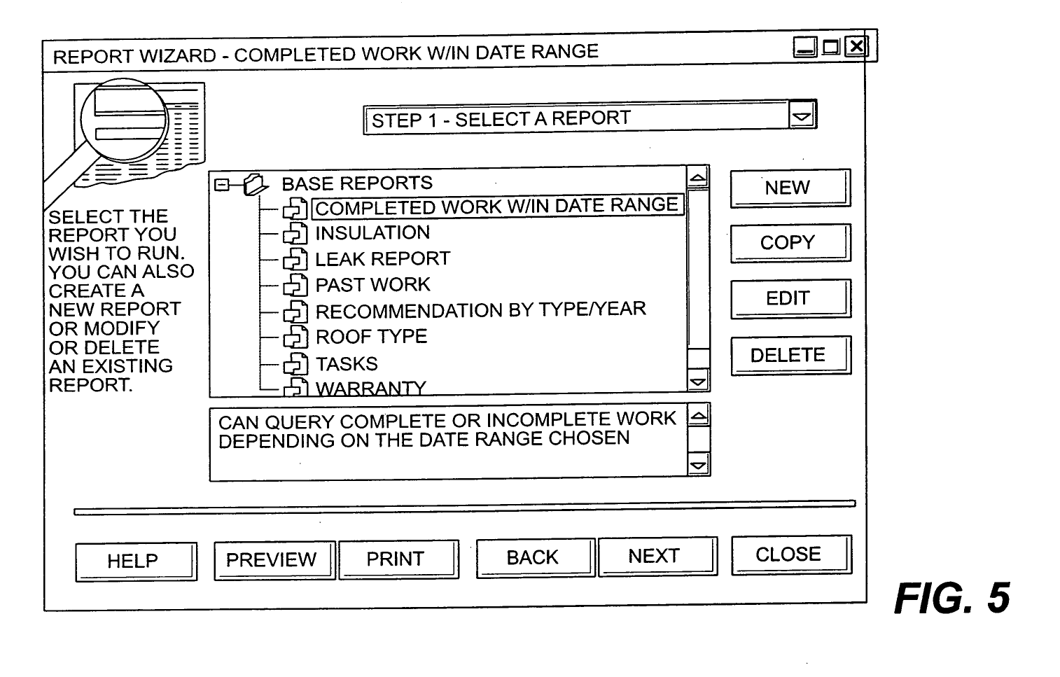

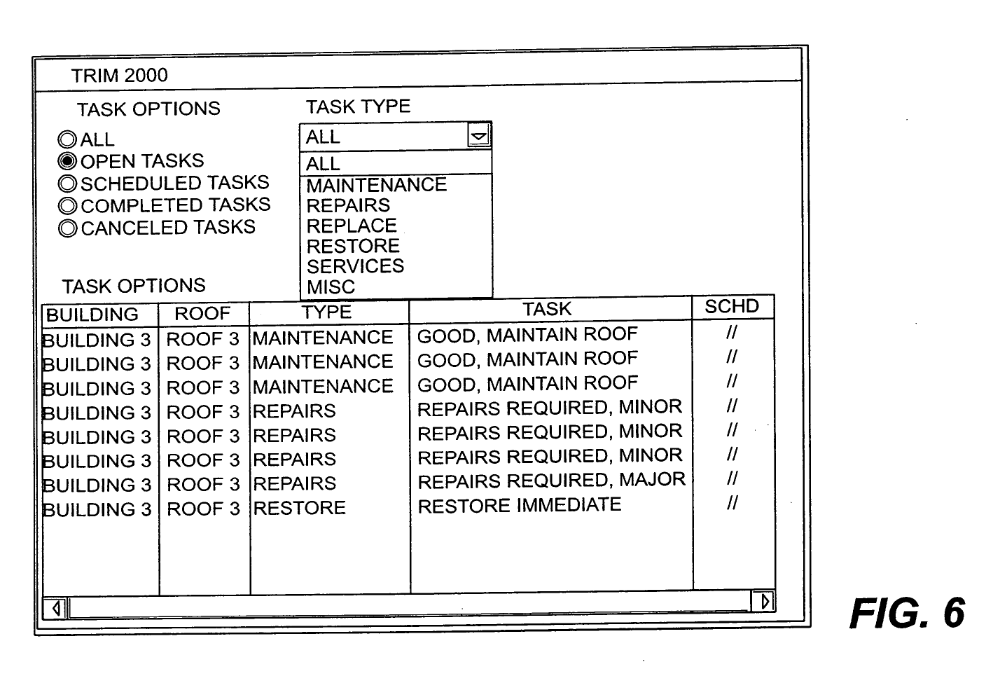

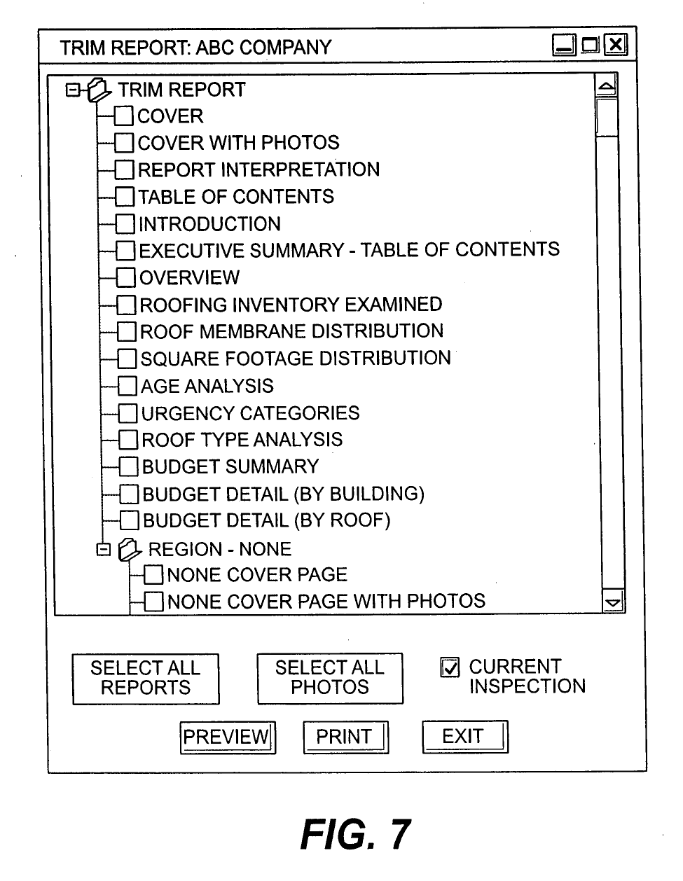

The interface of the MMIS 600, using as an example the RMIS system, provides the details screen as shown in FIG. 3 which includes the detailed information of different portions of a roof. Via the details screen, a user can access CAD drawings or digital photos of the roof, glossary diagrams (FIG. 4), thermal infrared analyses, data of humidity and asbestos tests (patent numbers to be incorporated by reference), or the scanned warranty. A variety of reports (FIG. 5) can be generated by the MMIS 600 with summary by total, region, facility or task (FIG. 6) or selected portions (FIG. 7) and presented by bar, pie or other charts.

An additional benefit of establishing an ongoing preventive-maintenance program according to the present invention is that it allows for a planned, organized approach to management of a roof asset, as well as for responsible, timely preparation of long-term capital assets, expenditures. Up to 80% of roof leaks occur from cracked or separated flashing due to age or movement of the roof. The preventive maintenance work includes units, exhaust, vents, plumbing stacks, power line boxes, drains, skylights and perimeter. In order to keep a roof from premature aging, a protective layer of coating is applied depending on the type of roof so as to seal all cracks and crevices. Reconditioning the roof and extending the life also gives a reflective finish to help lower cooling cost. Preventive maintenance work is included with the performance warranty 1400, which is bundled with the initial contract for conducting the initial repair 300, restoration 400 or replacement or installation a new roof 500.

Failure to comply with the requirements of the contract, such as allowing the routine inspections, by the owners or managers may invalidate the performance warranty 1400, especially if a condition not covered by the warranty is later determined to be the principal cause of roof failure. In some cases, visual inspections and surface repairs may not be enough; and a more comprehensive analysis of the roof may be required in order to fully evaluate its condition. Laboratory tests of core samples can be done to determine the internal condition of the roof, while non-destructive moisture analysis can identify and measure the amount of moisture hidden within the roof.

The method of the present invention provides a warranty to owners, facility managers, contractors, and all other roofing professionals. The warranty is totally different from the two traditional categories of roofing or other capital equipment warranties: a contractor's warranty covers workmanship, and a manufacturer's warranty covers materials. In the system of the present invention, all repairs include a limited guarantee on work performed. All the services are carried out through quality assurance with each product and by trained, qualified professional staff. All material manufacturers carry product liability insurance and publish varying degrees of disclaimers by design. All contractors, all consultants, material manufacturers and roofing contractors carry liability insurance prior to making critical recommendations or choices. All the services are carried out through quality assurance with each product and trained qualified professionals. All work is guaranteed, under private or public liability insurance to offer stability and security for the roofing. The present invention combines the above elements and goes one step further by transferring the risk of maintaining the capital equipment from the owner to the warranty provider.

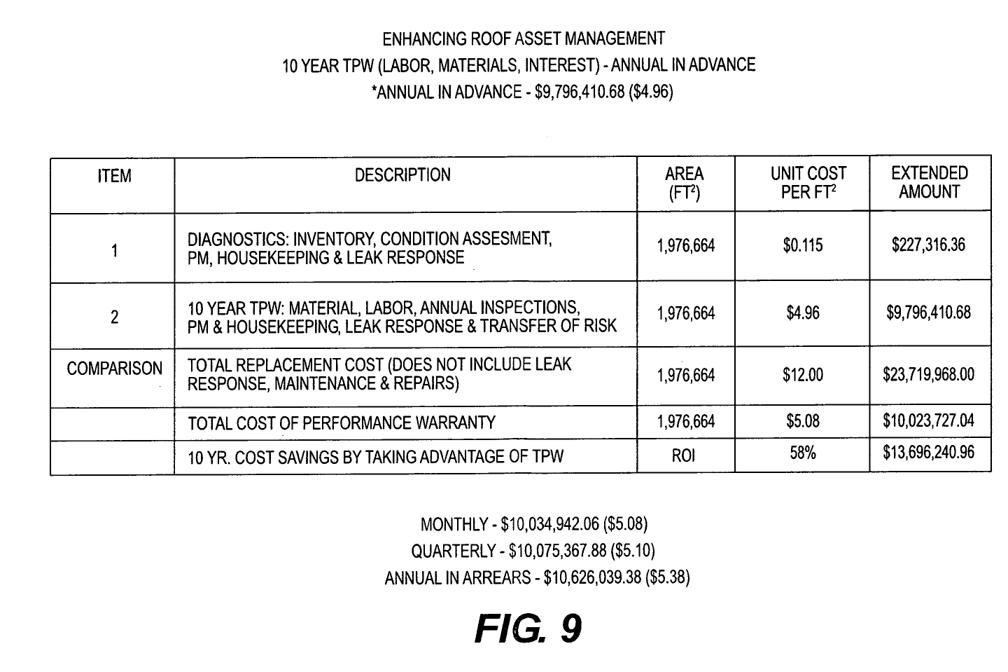

The preventive maintenance programs of the invention help facility managers to extract the best value. The invention further designs warranty customized to help the federal government agencies to meet federal mandates, offering solutions in performance-based contracting, outsourcing and energy management. The invention makes it fast, simple and convenient for federal agencies to procure the roofing and facility management solutions with best value pricing. As shown in FIG. 9, the prior art replacement approach cost $12 per Sq. Ft., while the TPW approach (diagnostics cost $0.115 per Sq. Ft. +10-year maintenance $4.96 per Sq. Ft.) merely costs $5.08 per Sq. Ft. and results in a 58% cost saving (ROI). In term of 1,976,664 Sq. Ft., the saving will be over 13.6 millions. The cost per Sq. Ft. is cheapest at $4.96 is pay in advance, at $5.08 if pay monthly, at $5.10 if pay quarterly, and at $5.38 pay annually in arrears.

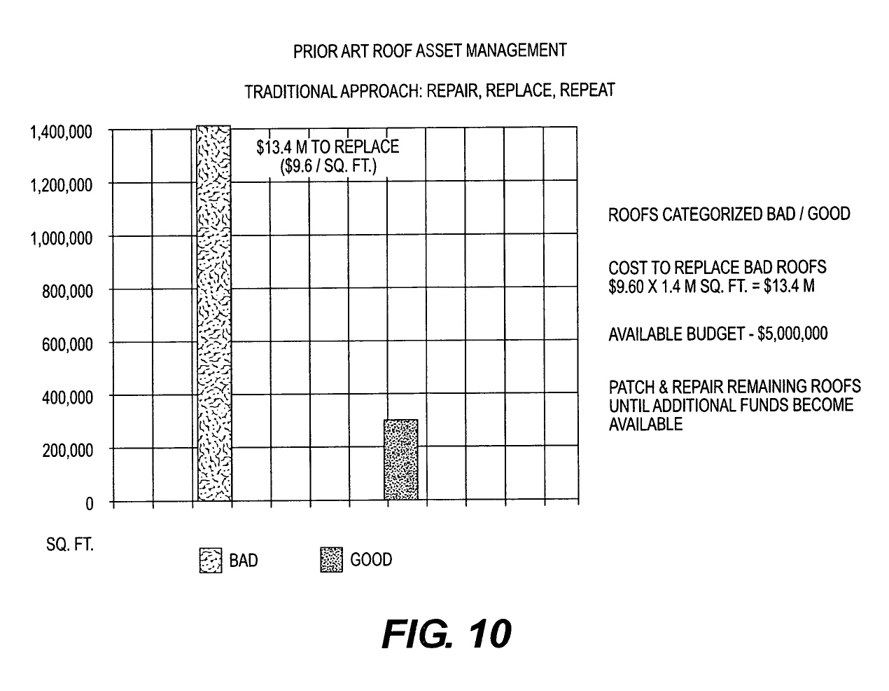

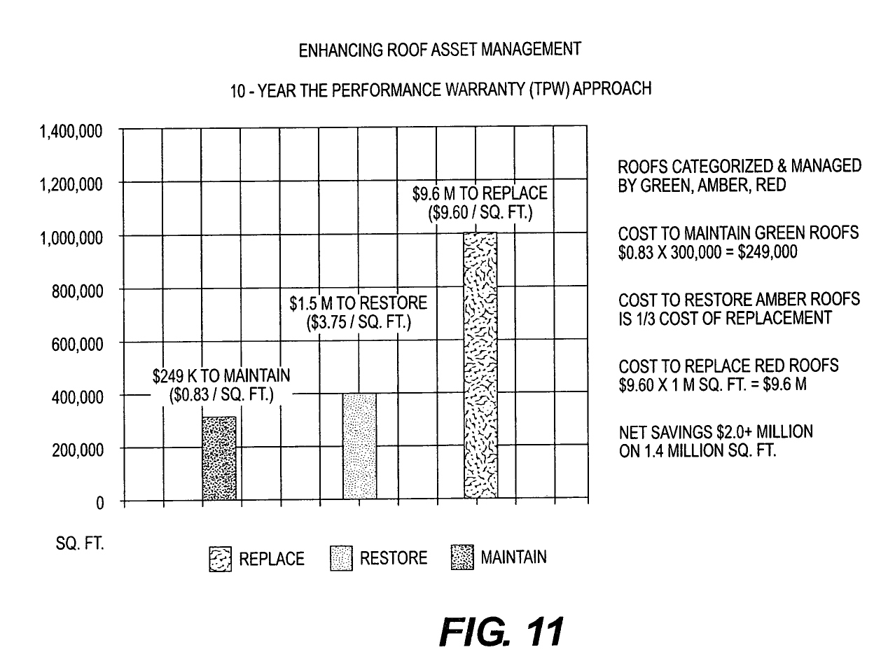

FIGS. 10-12 illustrate another comparison between the prior art approach and the TPW approach of the invention. The prior art shown in FIG. 10 only categorizes the conditions of long-term capital assets, equipment or fixtures, such as roofs as “bad” or “good,” and then replaces the portions determined as “bad.” In this example, the cost to replace bad roof will be $13.4 million, while the available budget is only $5 millions. As such, the prior art ends up patch or repair the remaining “bad” roofs until additional funds become available. On the other hand, the 10-yr TPW approach of the invention categorizes the conditions of different roofs as “Green,” “Amber” or “Red.” Generally speaking, a “Green” roof takes no or preventative maintenance and housekeeping to last another 10 years, an “Amber” roof needs to be restored to last another 8-10 years (otherwise last only 4-7 years), and a “Red” roof needs to be replaced (otherwise only last another 0-3 years).

The definitions of the color codes can be specified by the owner and the provider during their negotiation. Another example is provided in Table 1 as follows:

TABLE 1

| color code | grading | conditions |
|---|---|---|
| Green | 0-30 | 10+ yrs |
| Amber | 31-70 | restored 8-10 yrs |
| | 31-50 | |
| | 51-70 | replaced 4-7 yrs |
| Red | 71-100 | replaced 0-3 yrs |

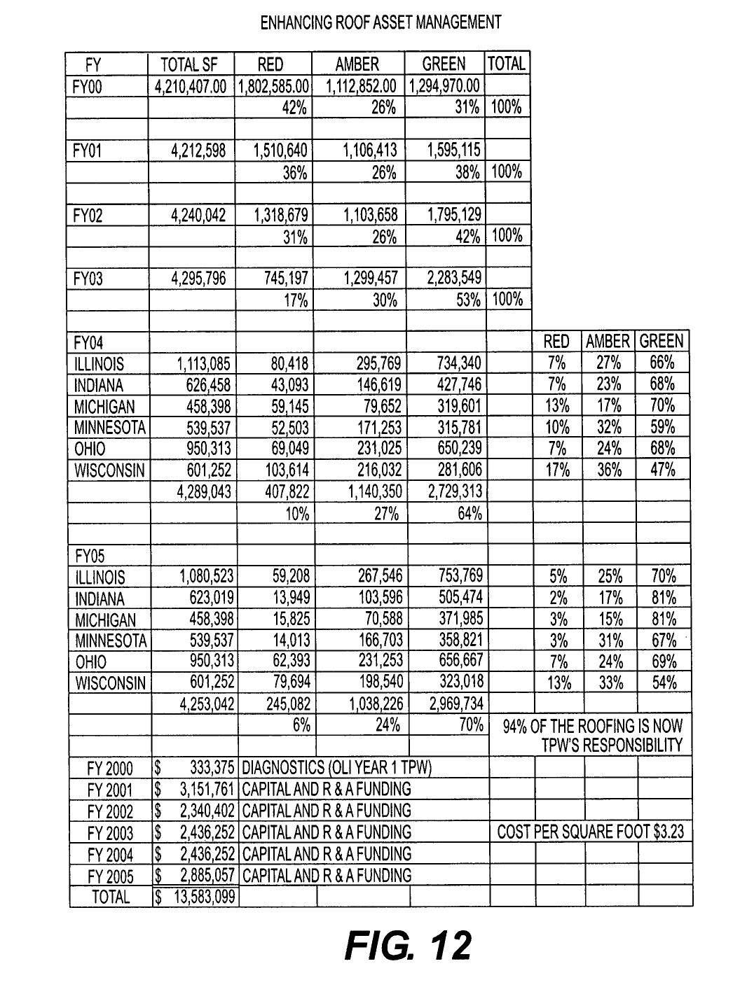

The cost of maintaining Green roofs is $0.83 per Sq. Ft. The cost of restoring Amber roofs is $3.2 per Sq. Ft. The cost of replacing Red roofs is $9.6 per Sq. Ft. In this example, the total saving of for 1.4 million Sq. Ft. will be over $2 millions. FIG. 12 shows the details of the cost calculation by state and per finical year.

Rather than color-coding per roof, the color-coding can be applied to different portions of one roof.

Restoration is a cost-effective, proactive maintenance process designed to prolong the life of a functioning built-up, modified, singly ply or metal roof. Determined from laboratory analysis, restoration upgrades the performance of an existing roof and its components by identifying and repairing defects in addition to providing a new top coat to restore waterproofing continuity.

For example, a gravel built-up roof restoration process uses a cold applied, high performance flood coat of waterproofing bitumen that reconditions the surface of an aging built-up roof. Its special blend of natural and synthetic fibers provides a thick film that smoothens minor imperfections such as hairline cracks. Gravel is then embedded for maximum impact and fire resistance.

Advantages to Gravel Roof Restoration: Experience has shown that restoration can dramatically extend the service life of a built-up roof and delay replacement for many years. The cost of restoration is far less than replacement with a comparable roof and represents an excellent value through cost avoidance by protecting an existing investment. The restoration process can be repeated in most instances, truly maximizing the service life of the roof. Since little or no roof membrane is removed during restoration, interruption of building activity is minimized. Reusing the existing roof saves tear-off and disposal costs, as well as being environmentally considerate. Low odor cold process restoration eliminates disruptions due to noxious fumes and alleviates building occupants' health concerns related to roof work.

Steps in Gravel Roof Restoration: 1. Analysis: To determine if a roof is suitable for restoration, The provider's roofing experts perform visual inspections, an infrared moisture analysis, and a roof core analysis & asbestos test which will be tested at a research center. These tests provide factual laboratory data on the construction and condition of the built-up roof. 2. Preparation: Proper preparation of the roof surface is critical to the success of the restoration process: For gravel roofs, all loose gravel, dirt and debris are removed and the entire surface is cleaned prior to work commencing. 3. Repair & Enforcement: Spot Replacement—Membrane faults must be repaired or replaced to prevent any further roof deterioration. Increased Strength—Blisters, ridges and other defects in the membrane and mastic. Flashings, gravel stops and other projections are repaired and reinforced so that they are stronger than original. 4. Renewed Protection: Added Reinforcement—Additional polyester or glass membrane may be incorporated into the top coat to reinforce and strengthen the system. Improved Waterproofing—A cold applied restorative top pour tenaciously bonds to the aged top pour, filling the grooves and penetrating the areas of exposed and weathered felts. Enhanced Weather Barrier—As a barrier against ultraviolet light and its photo-oxidizing effects, gravel or a reflective coating protects and covers the top pour and membrane. Extended Life—A properly restored roof gives years of added service life.

Further more, the invention keeps buildings weather-tight beyond the warranty period. The owner may include an optional “condition warranty” 1410 into the performance warranty 1400 to guarantee an additional fixed life expectancy (e.g., 10 more years) of the capital assets, equipment or fixtures beyond the end of a predetermined fixed term for maintaining the capital assets, equipment or fixtures.

At the end of the predetermined fixed term for maintaining the capital assets, equipment or fixtures, a determination is made as to the current life expectancy of the capital assets, equipment or fixtures. The equipment or fixtures is evaluated by component to determine to be in a condition current life expectancy being (a) consistent with the additional fixed life expectancy; (b) below the additional fixed life expectancy; or (c) exceeding the additional fixed life expectancy. In cases of (a) and (c), no further action will be taken by the warranty servers provider. In case of (b), the warranty service provider, at its own cost, will take necessary actions to replace or repair “by component” to extend the current life expectancy to be the additional fixed life expectancy, prior to the beginning of the additional life expectancy period. Once entering into the additional life expectancy period, no regular inspection or maintenance will be performed. As mentioned, these components include; the substrate (ordeck), insulation, penetrations, flashings (Parapet wall, Curb, Gutter, Roof to wall termination etc.), and roof top equipment, etc.

Prior to the end of the performance warranty period, the warranty servers provider, at its own cost, will take necessary actions to replace or repair “by component” to extend the current life expectancy to theoretically last until the end of the additional life expectancy period based upon industrial expediencies data. Determined from laboratory analysis, restoration upgrades the performance of the components by identifying and repairing defects and providing a new top coat to restore waterproofing continuity. However, the provider will not inspect, maintain, restore or repair thereafter, even if the long-term capital assets, equipment or fixtures fail to perform during the additional life time period.

The condition warranty 1400 excludes damage due to earthquake, flood, “Acts of God”, war (including a nuclear explosion from any source) fire or lightning, windstorm or hail, vandalism or malicious mischief, theft, damage from vehicles and aircraft, explosion, riot or civil commotion, smoke, building collapse; freezing of or accidental discharge of water or steam from internal plumbing, heating, air-conditioning systems or domestic appliances, falling objects, weight of ice, snow or sleet damaged cause by, rupture or bursting of pipes.

However, the owner may pay more to remove the excluded items. The more perils the condition warranty 1400 covers, the more the owner will pay additionally.

The condition warranty 1400 is essentially different from the conventional extended property insurance in that the latter does not conduct evaluation by component to determine a condition current life expectancy and take necessary actions to replace or repair by component to extend the current life expectancy to be the additional fixed life expectancy, prior to the beginning of the additional life expectancy period. In addition, the latter only repairs the damaged property to an condition “as was” prior to the damage, rather than to replace or repair by component to extend the current life expectancy to last till the end of the additional fixed life expectancy period.

The condition warranty 1400 is also different from the common personal property purchase insurance. Such purchase insurance is aimed at providing protection on the products people purchase. Purchase insurance may cover individual purchase protection, warranties, guarantees, care plans and even mobile phone insurance. Such insurance is normally very limited in the scope of problems that are covered by the policy. In addition, the latter usually replaces the defective product with a new one with a new initial warranty period which does not involve any additional fixed life expectancy period.

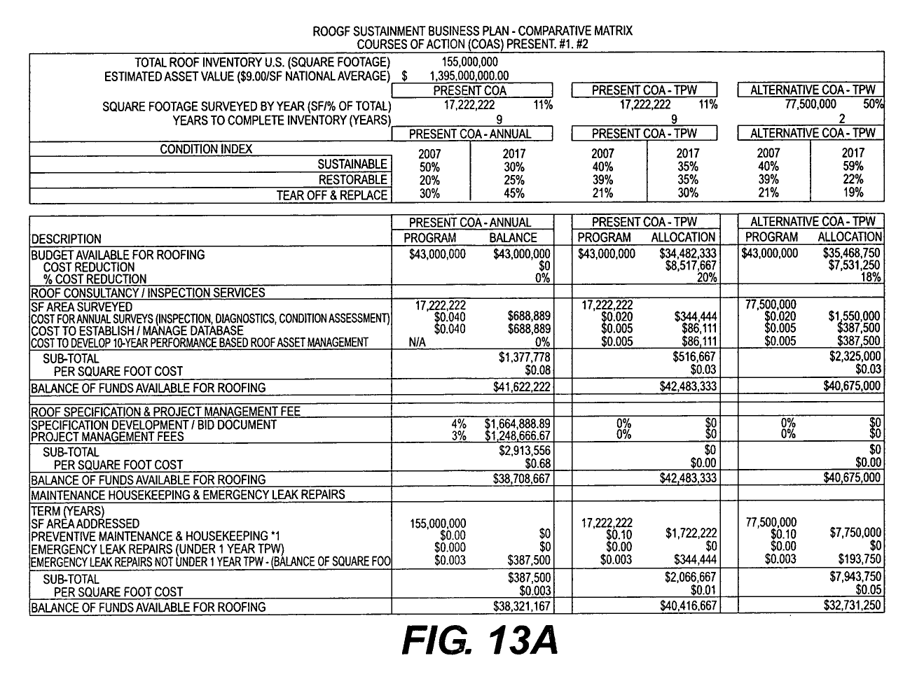

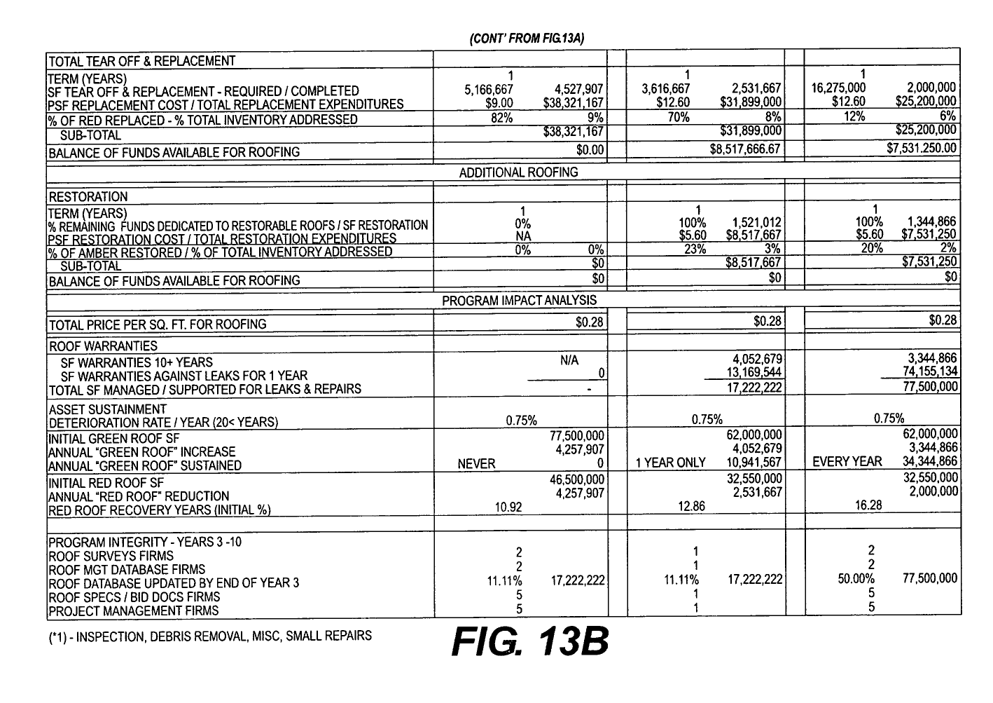

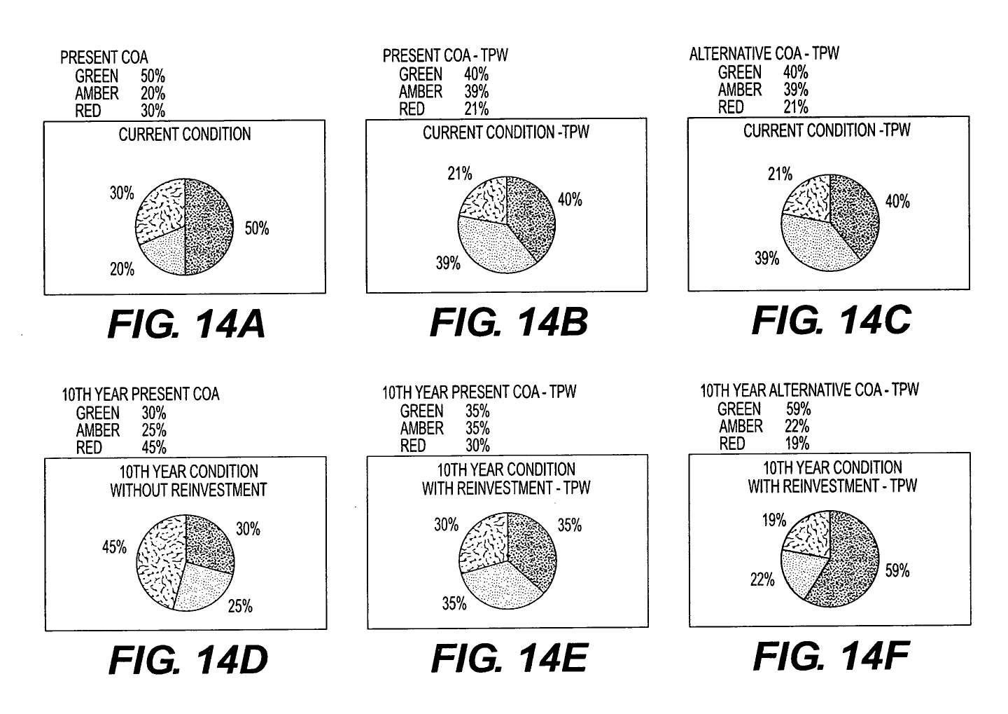

FIGS. 13-14 illustrate a third cost comparison example between a modified prior art approach, a TPW approach with condition warranty (CW), and an alternative TPW approach with CW of the invention.

FIG. 13 includes three columns representing three approaches. All three approaches are designed to gradually cover 155,000,000 Sq. Ft. of roof inventory and subject to a program budget of $43,000,000.

The first column shows a modified prior art approach. As mentioned, the prior approach only determines roofs as “bad (to be replaced)” or “good (no action to be taken).” For the benefits of comparison, the first column shows a modification of the prior art approach by applying the color condition coding of the invention to have color codes, i.e., course of actions (COAs) as Green: Amber: Red=50%: 20%: 30% in 2007 (FIG. 14A). The second column shows a TPW approach. To contrast the effectiveness of the invention (any other reasons?), this approach starts with worse conditions than the modified prior art approach, i.e., Green: Amber: Red=40%: 39%: 21% in 2007 (FIG. 14B).

Both the modified prior art approach and the TPW approach are designed to finish the inventory in 9 years by covering 17,222, 222 Sq. Ft. (11%) annually. In the first year, the modified prior art approach spends most of the budget to replace 82% of the Red roofs and does nothing to restore the Amber roofs. In contrast, the TPW approach replaces 70% of the Red roofs and restores 23% of the Amber roofs. In addition, the TPW approach save 3.8 millions dollars for roof repairs by spending 60% less than the prior art approach in roof consultancy and inspection services and absorbing the alleged roof specification and project management fees into the performance warranty.

Most importantly, the TPW approach repairs or restores over 4 million Sq. Ft. to set them under the coverage of 10-year condition warranty, and covers the remaining area of the 17,222, 222 Sq. Ft. under 1-year performance warranty. By upgrading amber roofs to green roofs, the TPW approach increases green roofs at a fast speed than the modified prior art approach and sustains the green roofs longer via preventative maintenance and housekeeping (including inspection, debris removal, miscellaneous small repairs, etc.).

For a green roof that was replaced from a Red roof or that was restored from an Amber roof by the provider, the 10-year condition warranty is available even if the owner does not continue the performance warranty year after year for 10 years. However, for a Green or Amber roof which was under a one-year performance warranty but never had any capital improvement (being repaired, restored, or replaced) done thereonto, the 10-year condition warranty is not available if the owner does not continue the performance warranty year after year for 10 years. For example, if the owner discontinues the performance warranty per year after six years, those roofs ever received capital improvement by the provider will be protected by the condition warranty such that the provider still has to show up at the 10^{th} year to check those roofs by component if they all meet the requirements for another 10 year life expectancy. However, for those roofs never received capital improvement by the provider, they are not protected by the condition warranty such that the provider will not show up at the 10^{th} year to check those roofs by component if they all meet the requirement for another 10 year life expectancy.

Moreover, the TPW approach only involves one company for surveying, database management, specification/bidding, and project management, rather than several different companies as does as does the modified prior art approach (see the last row of FIG. 13).

At the end of 2017, the modified prior art approach has Green: Amber: Red=30%: 25%: 45% (FIG. 14D), and the TPW approach has Green: Amber: Red=35%: 35%: 30% (FIG. 14E).

The third column shows an alternative/accelerated TPW approach which is designed to finish the inventory in 2 years by covering 77,500,000 Sq. Ft. (50%) annually. This approach starts with the same conditions as the TPW approach, i.e., Green: Amber: Red=40%: 39%: 21% in 2007 (FIG. 14C). It spends 7.6 millions dollars more than the TPW approach to inspect and maintain more inventory in one year, such that less budget is left for replacing the Red roofs and restoring the Amber roofs. The alternative TPW approach replaces 12% of the Red roofs and restores 20% of the Amber roofs. By covering more inventory in one year, the alternative TPW approach covers 700,000 Sq. Ft. less than the TPW approach under the 10-year condition warranty, but has 5.6 times more (62,000,000 Sq. Ft.) under 1-year performance warranty and more Green roofs sustained. At the end of 2017, the TPW approach has Green: Amber: Red=35%: 35%: 30% (FIG. 14E), and the alternative TPW approach has Green: Amber: Red=59%: 22%: 19% (FIG. 14F).

The invention decreases cost of 25% during the first ten years while extending the useful life of the roof three folds which results in a 67% cost decrease during the years 11-20.

The contract generated under step 1500 may include a host of roof maintenance services including but not limited to: a 24 hour leak hotline and routine preventive maintenance, training the owners' or the managers' maintenance personnel to perform basic problem identification and roof repairs, turnkey services to reduce owners' participation, etc. For example, the system of the present invention can include providing seminars that cover important topics such as the cost of quality, flashing details and design, the significance of good roof design, how to select the warranty, and other good roofing practices.

The genesis of the invention are (1) managing all maintenance service via a life cycle approach; (2) and integrating all information under one software; and (3) transferring all maintenance risk to the service provider via the warranty.

The Performance Warranty (“TPW”) of the invention is specifically designed for federal agencies, creating a leak-free environment by installing high performance, long lasting weatherproofing systems and products. The Performance Warranty shifts the risk of the performance from the building owners to the maintenance service & warranty provider, while providing the best value in terms of life-cycle costs and product quality. The Performance Warranty takes a proactive approach—including maintenance, inspection and if required, even emergency repairs.

In contrast, the traditional provider of the service is only responsible for meeting the service requirements as defined by the agreed scope of work. Under such a scheme, the service providers always limit their risk through negotiated terms and conditions of the scope of work. The work, such as Patch and Repair and roof restoration, is bundled into customer proposals and broken into the various components and costs. Even with bundling, roof performance risk remains largely on the customer.

The warranty also resolves the problem of limits imposed by public financing laws by bundling the warranty with an initial service contract. Current year public funds may be used to purchase a multiyear warranty consistent with industry standards. The warranty transfers performance risk through the use of performance work statements and outcome measurements in the initial service contact, namely, “what” is expected as an outcome rather than “how” the work is to be accomplished. The warranty acts as an umbrella for total roof performance. To that end, services ranging from simple patch and repair through total roof replacement may be necessary and cosseted into the price of the warranty.

In other words, the warranty essentially privatizes the performance of the roof or component covered by the warranty and allows the owners to lock in the cost of maintenance. The warranty addresses the concerns within the public and private sectors. The warranty assumes liability for the facility component covered with standard exclusions such as unauthorized (coordinated) changes or abuse to the structure and acts of God. The warranty may be issued/sold for up to 20 years, consistent with industry standards for roof warranties. The warranty allows the owners or managers to focus on their core business activities rather then the facility maintenance.

The system of the invention can be applied to all kinds of commercial or residential premises, including at least with respect to the roof maintenance example. The application of the present invention extends to not only roof repair and maintenance, but also any long-term capital assets, investment fixtures that require long-term maintenance and repair. This includes HVAC systems, roads, underground sewer systems, etc. In addition, the local weather conditions and building codes are incorporated into the predetermined start-up standard. One of skill in the art, given the disclosure of the present invention, would understand how each of the components of the system would be applied to the capital investment fixtures.

The principles, preferred embodiments and modes of operation of the present invention have been described in the foregoing specification. However, App '843 which is intended to be protected is not limited to the particular embodiments disclosed. The embodiments described herein are illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A method for a third party provider to guarantee the performance of long-term capital assets, equipment or fixtures of an owner by managing and maintaining all components of the long-term capital assets, equipment or fixtures for a specified period of time so as to allow the owner to better plan and prioritize limited budget resources, comprising the steps of: (1) diagnosing existing conditions of the long-term capital assets, equipment or fixtures by the provider to determine if any repairs are required to bring the long-term capital assets, equipment or fixtures to a predetermined start-up standard of performance, said predetermined start-up standard of performance being negotiated between the owner and the provider; (2) repairing the long-term capital assets, equipment or fixtures by the provider to reach the start-up standard if any of the existing conditions are below the predetermined start-up standard; (3) developing a maintenance schedule by the provider to perform recurrent inspections, preventive maintenance, and housekeeping on the long-term capital assets, equipment or fixtures so as to maintain the long-term capital assets, equipment or fixtures at a standard of performance for a specified period of time, said standard of performance being negotiated between the owner and the provider and set to within industry acceptable parameters; and (4) providing a performance warranty by the provider on the long-term capital assets, equipment or fixtures in conjunction with the purchase by the owner of performance of the (1)-(3) steps, said providing of the performance warranty including transferring from the owner to the provider the technical and financial risk including costs associated with managing and maintaining all components of the long-term capital assets, equipment or fixtures within the standard of performance during the specified period of time,
wherein the improvement comprises a condition warranty which is included in the performance warranty and guarantees conditions of the long-term capital assets, equipment or fixtures by component as at the end of the specified period of time of the maintenance warranty so as to guarantee the long-term capital assets, equipment or fixtures will operate for another extended period after the specified period of time, without performing by the provider any further maintenance thenafter.

2. The method according to claim 1, wherein the diagnosing step further comprising a step of inspecting at least one site where the long-term capital assets, equipment or fixtures are located.

3. The method according to claim 1, wherein the diagnosing step further comprising a step of interviewing at least one owner or manager of the long-term capital assets, equipment or fixtures.

4. The method according to claim 1, further comprising a step of generating a report on results of the diagnosing step.

5. The method according to claim 1, further comprising a step of inputting and analyzing results of the diagnosing step.

6. The method according to claim 5, further comprising a step of providing recommendations for any necessary repairs and cost estimates.

7. The method according to claim 1, wherein the maintaining step further comprising a step of inspecting the long-term capital assets, equipment or fixtures according to the maintenance schedule so as to adjust the maintenance schedule.

8. The method according to claim 7, wherein the maintaining step further comprises a step of inputting results of the inspection step executed according to the maintenance schedule.

9. The method according to claim 1, wherein the step of transferring the risk includes transferring 100% of the risk from the owner to the provider.

10. The method according to claim 1, wherein the step of transferring the risk includes transferring 100% of the risk, except for unauthorized changes, abuse to the structure and acts of God from the owner to the provider.

11. The method according to claim 1, further comprising determining by component, at the end of the specified period of time, a current life expectancy of components of the capital assets, equipment or fixtures.

12. The method according to claim 11, further comprising comparing by component said current life expectancy with said additional life time period; and
below the additional fixed life expectancy; and if said current life expectancy is shorter than said additional life time period, the provider, at its own cost, replaces or repairs the respective component to extend said current life expectancy to be said additional life time period, prior to the beginning of the additional life time period.

13. The method according to claim 11, wherein the long-term capital assets, equipment or fixtures is a roof, and the components include a substrate, insulation, penetrations, flashings, and roof top equipment.

14. The method according to claim 11, wherein the long-term capital assets, equipment or fixtures is a roof, and the standard of performance is defined as dryness of the roof.

15. The method according to claim 1, wherein the diagnosed existing conditions of the long-term capital assets, equipment or fixtures include at least three categories: nothing-to-be-done, to-be-restored, to-be-replaced.

16. The method according to claim 15, wherein the categories are applied per unit or per portions in each unit to the long-term capital assets, equipment or fixtures.

17. The method according to claim 15, wherein the performance warranty is renewed annually, and
the condition warranty is only available for to-be-restored roofs or to-be-replaced roofs after restoration and replacement are preformed by the provider, if the owner discontinues the performance warranty prior to the end of the specified period of time.

18. A method for a third party provider to guarantee the performance of long-term capital assets, equipment or fixtures of an owner by managing and maintaining all components of the long-term capital assets, equipment or fixtures for a specified period of time so as to allow the owner to better plan and prioritize limited budget resources, comprising the steps of: (1) developing a maintenance schedule by the provider to perform start-up maintenance and periodical maintenance including recurrent inspections, preventive maintenance, and housekeeping on the long-term capital assets, equipment or fixtures so as to maintain the long-term capital assets, equipment or fixtures at a standard of performance for a specified period of time, said standard of performance being negotiated between the owner and the provider and set to within industry acceptable parameters, prior to inspecting the long-term capital assets, equipment or fixtures by the provider; (2) providing a performance warranty by the provider on the long-term capital assets, equipment or fixtures based upon the developed maintenance schedule, said providing of the performance warranty including transferring from the owner to the provider the technical and financial risk including costs associated with managing and maintaining all components of the long- term capital assets, equipment or fixtures within the standard of performance during the specified period of time; and (3) executing by the provider the maintenance schedule under the performance warranty.

19. The method according to claim 18, wherein the start-up maintenance involves:
inspecting and diagnosing existing conditions of the long-term capital assets, equipment or fixtures by the provider to determine if any repairs are required to bring the long-term capital assets, equipment or fixtures to the standard of performance; and
repairing the long-term capital assets, equipment or fixtures by the provider to reach the standard of performance if any of the existing conditions are below the standard of performance.

20. An automated system for a third party provider to guarantee the performance of long-term capital assets, equipment or fixtures of an owner by managing and maintaining all components of the long-term capital assets, equipment or fixtures for a specified period of time so as to allow the owner to better plan and prioritize limited budget resources, comprising: (1) means for diagnosing existing conditions of the long-term capital assets, equipment or fixtures by the provider to determine if any repairs are required to bring the long-term capital assets, equipment or fixtures to a predetermined start-up standard of performance, said predetermined start-up standard of performance being negotiated between the owner and the provider; (2) means for repairing the long-term capital assets, equipment or fixtures by the provider to reach the start-up standard if any of the existing conditions are below the predetermined start-up standard; (3) means for developing a maintenance schedule by the provider to perform recurrent inspections, preventive maintenance, and housekeeping on the long-term capital assets, equipment or fixtures so as to maintain the long-term capital assets, equipment or fixtures at a standard of performance for a specified period of time, said standard of performance being negotiated between the owner and the provider and set to within industry acceptable parameters; and (4) means for providing a performance warranty by the provider on the long-term capital assets, equipment or fixtures in conjunction with the purchase by the owner of performance by the (1)-(3) means, said providing of the performance warranty including transferring from the owner to the provider the technical and financial risk including costs associated with managing and maintaining all components of the long-term capital assets, equipment or fixtures within the standard of performance during the specified period of time,
wherein the improvement comprises a condition warranty which is included in the performance warranty and guarantees conditions of the long-term capital assets, equipment or fixtures by component as at the end of the specified period of time of the maintenance warranty so as to guarantee the long-term capital assets, equipment or fixtures will operate for another extended period after the specified period of time, without performing by the provider any further maintenance thenafter.

21. A computer program product for a third party provider to guarantee the performance of long-term capital assets, equipment or fixtures of an owner by managing and maintaining all components of the long-term capital assets, equipment or fixtures for a specified period of time so as to allow the owner to better plan and prioritize limited budget resources, comprising: (1) a diagnosing module for diagnosing existing conditions of the long-term capital assets, equipment or fixtures by the provider to determine if any repairs are required to bring the long-term capital assets, equipment or fixtures to a predetermined start-up standard of performance, said predetermined start-up standard of performance being negotiated between the owner and the provider; (2) a repairing module for repairing the long-term capital assets, equipment or fixtures by the provider to reach the start-up standard if any of the existing conditions are below the predetermined start-up standard; (3) a maintenance schedule module for developing a maintenance schedule by the provider to perform recurrent inspections, preventive maintenance, and housekeeping on the long-term capital assets, equipment or fixtures so as to maintain the long-term capital assets, equipment or fixtures at a standard of performance for a specified period of time, said standard of performance being negotiated between the owner and the provider and set to within industry acceptable parameters; and (4) a warranty module for providing a performance warranty by the provider on the long-term capital assets, equipment or fixtures in conjunction with the purchase by the owner of performance by the (1)-(3) modules, said providing of the performance warranty including transferring from the owner to the provider the technical and financial risk including costs associated with managing and maintaining all components of the long-term capital assets, equipment or fixtures within the standard of performance during the specified period of time,
wherein the improvement comprises a condition warranty which is included in the performance warranty and guarantees conditions of the long-term capital assets, equipment or fixtures by component as at the end of the specified period of time of the maintenance warranty so as to guarantee the long-term capital assets, equipment or fixtures will operate for another extended period after the specified period of time, without performing by the provider any further maintenance thenafter.
